(19) United States
(12) Patent Application Publication
(10) Pub. No.: US 2019/0077509 A1
(43) Pub. Date: Mar. 14, 2019

(54) METHOD OF FAR-END CONTROL FOR UNMANNED AERIAL VEHICLE

(71) Applicant: ROUND-P TECHNOLOGY CO., LTD., Zhubei City (TW)

(72) Inventors: Jung-Kuo Hsu, Zhubei City (TW); Hsin-Yen Hsieh, Zhubei City (TW)

(21) Appl. No.: 16/130,554

(22) Filed: Sep. 13, 2018

(30) Foreign Application Priority Data
Sep. 14, 2017 (TW) 106131526

(51) Int. Cl. B64C 39/02; G05D 1/00; H04N 7/18

(52) U.S. Cl. CPC B64C 39/024; G05D 1/0016; B64C 2201/146; G05D 1/0038; H04N 7/185; G05D 1/0022

(57) ABSTRACT

A method of far-end control for unmanned aerial vehicle provides a near-end remote control device and a far-end remote control device, the former comprising a remote control module predefinedly matched with the vehicle for manipulating same within a predefined geographic range; transmits image data by the vehicle to the near-end remote control device; transmits image data by the near-end remote control device to the far-end remote control device via internet according to a first network protocol; presents image data on a second display of the far-end remote control device; sends a first control instruction by the far-end remote control device to the near-end remote control device according to a second network protocol; and instructs said unmanned aerial vehicle through said remote control module, such that said unmanned aerial vehicle is allowed to carry out a corresponding operation according to said first control instruction.

### FIELD OF THE INVENTION

The present invention is related to a method of control for unmanned aerial vehicle, particularly to a method of far-end control for unmanned aerial vehicle.

### BACKGROUND OF THE INVENTION

An unmanned aerial vehicle, also referred to as unmanned carrier, is a carrier without a person on board, which is generally controlled by remote control, guidance or automatic piloting, and widely applied to cargo delivery, aerial photography, environmental surveillance and etc., owing to merits including vertical takeoff and landing as well as hovering in narrow space and complicated environment.

A common unmanned aerial vehicle, such as an unmanned vehicle described in Taiwan patent publication no. 201704096, includes a vehicle body and at least one arm assembly coupled to the vehicle body. The arm assembly includes a first rotating member, a second rotating member coupled to the first rotating member, and a propeller. The propeller includes a rim encircling an outer edge of the propeller. The propeller further includes a rotatable axle coupled to the second rotating member. The rotatable axle extends along a rotating axis. Moreover, the second rotating member is configured to turn the propeller by rotating the rotatable axle around the rotating axis. The first rotating member is configured to rotate and effect a movement of the second rotating member so as to selectively adjust the rotatable axle to align the rotating axis at least with a first axial direction and a second axial direction.

Furthermore, a way for the operation of the unmanned aerial vehicle is controlling the unmanned aerial vehicle through a remote control device, by which an operating signal may be emitted to the unmanned aerial vehicle, such that the unmanned aerial vehicle is operated according to the operating signal. However, a limited distance, mostly ranging from 2 km to 7 km, between the remote control device and the unmanned aerial vehicle is provided, due to limitations including the design, the adopted communication technology and etc., imposed by a supplier of the unmanned aerial vehicle. Once the distance is exceeded, unavailability and thus the limited use occur. Therefore, how to increase the remote control distance of the unmanned aerial vehicle is truly the subject for which the related industry struggles together.

### SUMMARY OF THE INVENTION

It is the main object of the present invention to solve the problem of incapability of far-end remote control, due to a limitation caused by a communication technology having a limited distance applied to a predefinedly matched remote control device provided by a supplier of an unmanned aerial vehicle, in a conventional method of manipulation for unmanned aerial vehicle.

For achieving the above object, the present invention provides a method of far-end control for unmanned aerial vehicle, comprising the steps of:

step 1: providing an unmanned aerial vehicle not having a hardware components thereon to connect to the internet wirelessly, a near-end remote control device and a far-end remote control device, the near-end remote control device comprising a remote control module predefinedly matched with the unmanned aerial vehicle and used for manipulating the unmanned aerial vehicle wirelessly by using a proprietary protocol instead of via the internet within a predefined geographic range, the far-end remote control device being far away from the near-end remote control device at a distance of at least the predefined geographic range;

step 2: transmitting an image data which is shot by the unmanned aerial vehicle to the near-end remote control device through said unmanned aerial vehicle;

step 3: transmitting the image data by the near-end remote control device to the far-end remote control device via an internet according to a first network protocol, in which the first network protocol is selected from the group consisting of 3G wireless network, 4G wireless network, 5G wireless network and TCP/IP;

step 4: receiving the image data by the far-end remote control device and presenting the image data on a second display of the far-end remote control device;

step 5: sending a first control instruction by the far-end remote control device according to a second network protocol, the first control instruction being transmitted to the near-end remote control device via the internet, in which the second network protocol is selected from the group consisting of 3G wireless network, 4G wireless network, 5G wireless network and TCP/IP; and

step 6: the near-end remote control device instructs the unmanned aerial vehicle through the remote control module, such that the unmanned aerial vehicle is allowed to carry out a corresponding operation according to the first control instruction.

To sum up, the first control instruction emitted by the far-end remote control device may be delivered to the near-end remote control device via the internet, and then the unmanned aerial vehicle far away can be manipulated by the near-end remote control device without being limited by a predefined remote control distance defined for the unmanned aerial vehicle when leaving the factory.

### BRIEF DESCRIPTION OF THE DRAWINGS

FIG. 1 is a system configuration diagram of a first embodiment of the present invention.

FIG. 2 is a software configuration diagram of the first embodiment of the present invention.

FIG. 3 is a software configuration diagram of a second embodiment of the present invention.

FIG. 4 is a system configuration diagram of a third embodiment of the present invention.

FIG. 5 is a software configuration diagram of the third embodiment of the present invention.

### DETAILED DESCRIPTION OF THE PREFERRED EMBODIMENTS

The detailed description and technical content of the present invention will now be described, in conjunction with drawings, as follows.

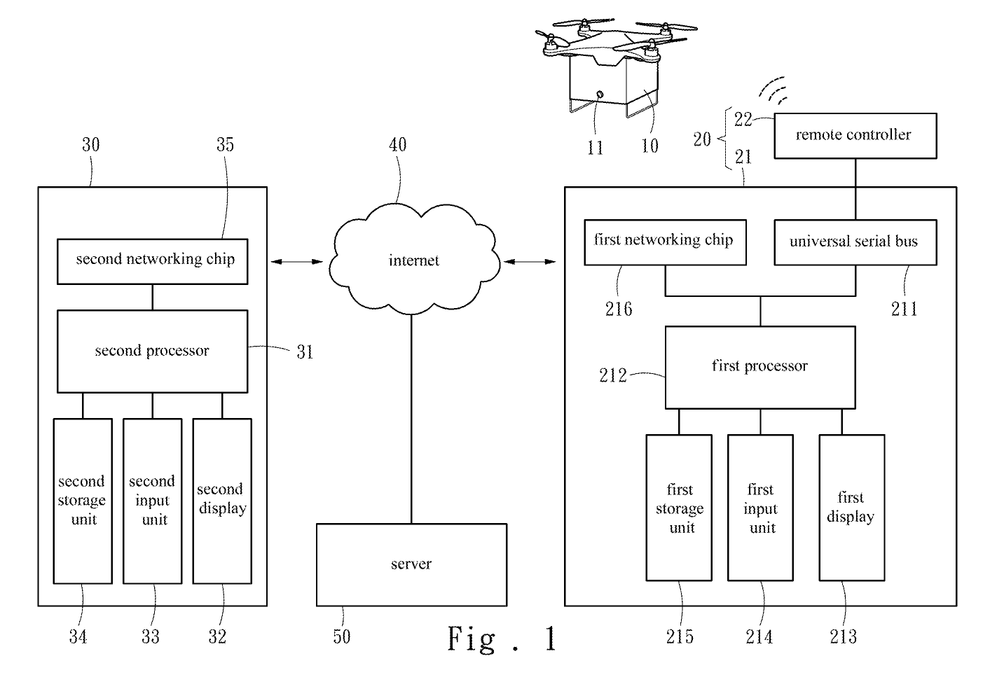

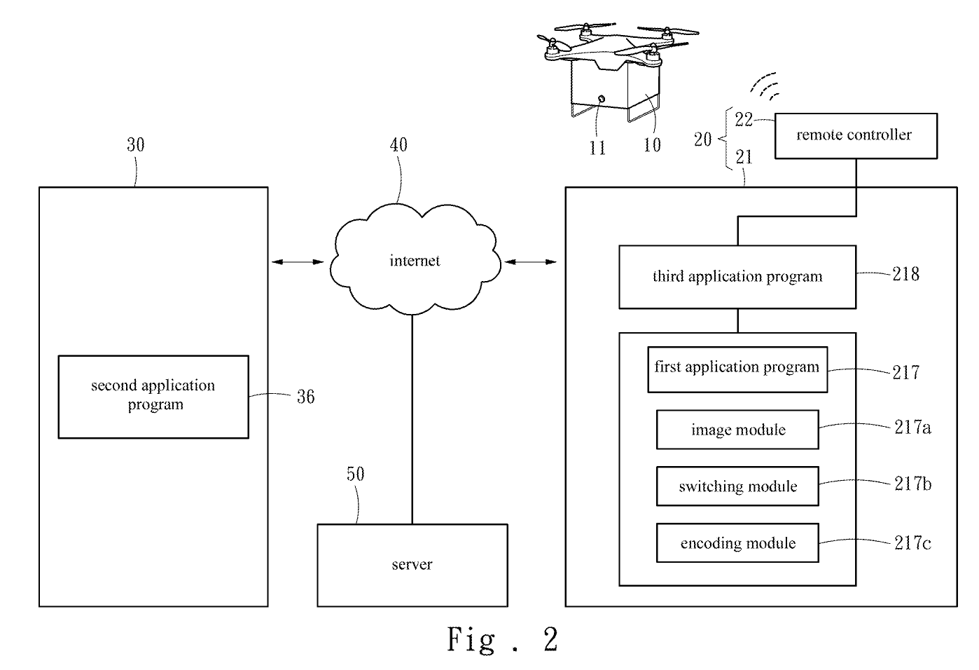

Referring to FIGS. 1 and 2, there are shown a system configuration diagram and a software configuration diagram, respectively, of a first embodiment of the present invention. The present invention is directed to a method of far-end control for unmanned aerial vehicle, carried out among an unmanned aerial vehicle 10, a near-end remote control device 20 and a far-end remote control device 30. The near-end remote control device 20 is provided with a remote control module predefinedly matched with the unmanned aerial vehicle 10 and used for manipulating the unmanned aerial vehicle 10 wirelessly within a predefined geographic range. The unmanned aerial vehicle 10 of the present invention is referred to as an unmanned aerial vehicle not having a hardware component to connect to the internet wirelessly. Namely, the unmanned aerial vehicle 10 is unable to connect to the internet wirelessly. So, the near-end remote control device 20 wirelessly communicates with the unmanned aerial vehicle 10 by using a proprietary protocol instead of via the internet.

In a first embodiment of the present invention, the remote control module is a remote controller 22 predefinedly matched with the unmanned aerial vehicle 10, and the near-end remote control device 20 further comprises a system 21 equipped with a processor (CPU). The one predefinedly matched with the unmanned aerial vehicle 10 herein is directed to what is attached to the unmanned aerial vehicle 10 by a supplier of the unmanned aerial vehicle 10 to be cooperated with this unmanned aerial vehicle 10. The remote controller 22 and the system 21 are connected in a wired manner. In this embodiment, the wired manner is implemented via a universal serial bus 211 provided on the system 21. Between the unmanned aerial vehicle 10 and the remote controller 22, signal transmission and manipulation may be performed in a manner of wireless communication, and limited by the wireless communication technology adopted by the supplier of the unmanned aerial vehicle 10. The system 21 may be an Android communication device, iOS communication device, PC-based system, embedded system, router, switch and so on.

In this embodiment, the Android or iOS communication device is taken as an example for the system 21. The system 21 is provided with a first processor 212, a first display 213, a first input unit 214, a first storage unit 215 and a first networking chip 216. The system 21 is connected to an internet 40 via the first networking chip 216 according to a first network protocol, the first network protocol being 3G wireless network, 4G wireless network, 5G wireless network, TCP/IP (Transmission Control Protocol/Internet Protocol) and so on. In the present invention, the far-end remote control device 30 is, preferably, an Android communication device, iOS communication device or PC-based system. Similarly, taking the Android or iOS communication device as an example, the far-end remote control device 30 is provided with a second processor 31, a second display 32, a second input unit 33, a second storage unit 34 and a second networking chip 35, in which the far-end remote control device 30 is connected to the internet 40 via the second networking chip 35 according to a second network protocol, the second network protocol being 3G wireless network, 4G wireless network, 5G wireless network, TCP/IP and so on.

Referring to FIG. 2, the system 21 of the near-end remote control device 20 is provided with a first application program 217, the first application program 217 comprising an image module 217a, a switching module 217b and an encoding module 217c. The image module 217a is used for processing and editing an image data obtained by an image capture device 11 of the unmanned aerial vehicle 10. The switching module 217b is provided for a user to determine whether the far-end remote control device 30 or the near-end remote control device 20 is allowed for manipulating the unmanned aerial vehicle 10 via the remote controller 22. The encoding module 217c is then used for transforming instructions appropriately. In this embodiment, for example, the system 21 of the near-end remote control device 20 is further shipped with a third application program 218, the third application program 218 being a software attached to the unmanned aerial vehicle 10 by the supplier of the unmanned aerial vehicle 10 to be cooperated with this unmanned aerial vehicle 10, such that the user is allowed to send the signal to the remote controller 22 via the third application program 218, and to further manipulate the unmanned aerial vehicle 10. In the present invention, the user is allowed to switch, via the switching module 217b, between a near-end remote control mode and a far-end remote control mode, the user manipulating the unmanned aerial vehicle 10 on the near-end remote control device 20 via the first application program 217 in the former, the user utilizing a second application program 36 on the far-end remote control device 30 to send a first control instruction to be transmitted to the first application program 217 of the near-end remote control device 20 according to the second network protocol in the latter. In each of the two modes, the received instruction may be encoded again by the encoding module 217c of the first application program 217 into that in a format readable by the third application program 218, in such a way that the unmanned aerial vehicle 10 may be manipulated by the user. In the present invention, the received instruction may be encoded, by the encoding module 217c, again into that in a format readable through the third application program 218 via open application programming interface (Open API) or software-development-kit (SDK) provided by the third application program 218.

Alternatively, the switching module 217b of the first application program 217 can optionally block the first control instruction from the far-end remote control device 30 so that only the user of the near-end remote control device 20 could control the unmanned aerial vehicle 10.

In the present invention, a method of controlling the unmanned aerial vehicle 10 by the far-end remote control device 30 via the near-end remote control device 20 comprising the steps of:

step 1: providing the unmanned aerial vehicle 10 not having a hardware components thereon to connect to the internet wirelessly, the near-end remote control device 20 and the far-end remote control device 30, the near-end remote control device 20 comprising the remote control module predefinedly matched with the unmanned aerial vehicle 10 and used for manipulating the unmanned aerial vehicle 10 wirelessly by using a proprietary protocol instead of via the internet within a predefined geographic range, the far-end remote control device 30 being far away from the near-end remote control device 20 at a distance of at least the predefined geographic range, the remote control module of the near-end remote control device 20 comprising the system 21 and the remote controller 22 in this embodiment;

step 2: transmitting an image data which is shot by the unmanned aerial vehicle 10 to the near-end remote control device 20 through said unmanned aerial vehicle;

step 3: transmitting the image data by the near-end remote control device 20 to the far-end remote control device 30 via the internet 40 according to the first network protocol;

step 4: receiving the image data by the far-end remote control device 30 and presenting the image data received from said near-end remote control device on the second display 32 of the far-end remote control device 30;

step 5: sending a first control instruction by the far-end remote control device 30 according to the second network protocol, the first control instruction being transmitted to the near-end remote control device 20 via the internet 40; and

step 6: instructing the unmanned aerial vehicle 10 through the remote control module of the near-end remote control device 20, such that the unmanned aerial vehicle 10 is allowed to carry out a corresponding operation according to the first control instruction. For example, in one embodiment of the invention, a first application program 217 of the near-end remote control device 20 performs an encoding operation on the first control instruction, followed by sending a second control instruction corresponding to the first control instruction to the unmanned aerial vehicle 10 by the remote controller 22, such that the unmanned aerial vehicle 10 is allowed to carry out a corresponding operation according to the first control instruction. In another embodiment of the invention, step 6 can be carried out without performing the encoding operation.

Furthermore, in the first embodiment of the present invention, step 6 further comprises the steps of:

step 6-1: performing the encoding operation on the first control instruction by the first application program 217 according to a format readable by the third application program 218 predefinedly matched with the unmanned aerial vehicle 10, so as to obtain an encoded instruction;

step 6-2: transmitting the encoded instruction to the third application program 218, then sending a signal by the third application program 218 to the remote controller 22 according to the encoded instruction; and

step 6-3: sending the second control instruction by the remote controller 22 to the unmanned aerial vehicle 10 according to the signal.

In one embodiment of the present invention, the method further utilizes a server 50, the server 50 being connected to the internet 40 in a wired or wireless manner, as well as used for exchanging and processing the image data and the first control instruction. In addition, the image data received by the near-end remote control device 20 may be also registered in the first storage unit 215 and displayed on the first display 213.

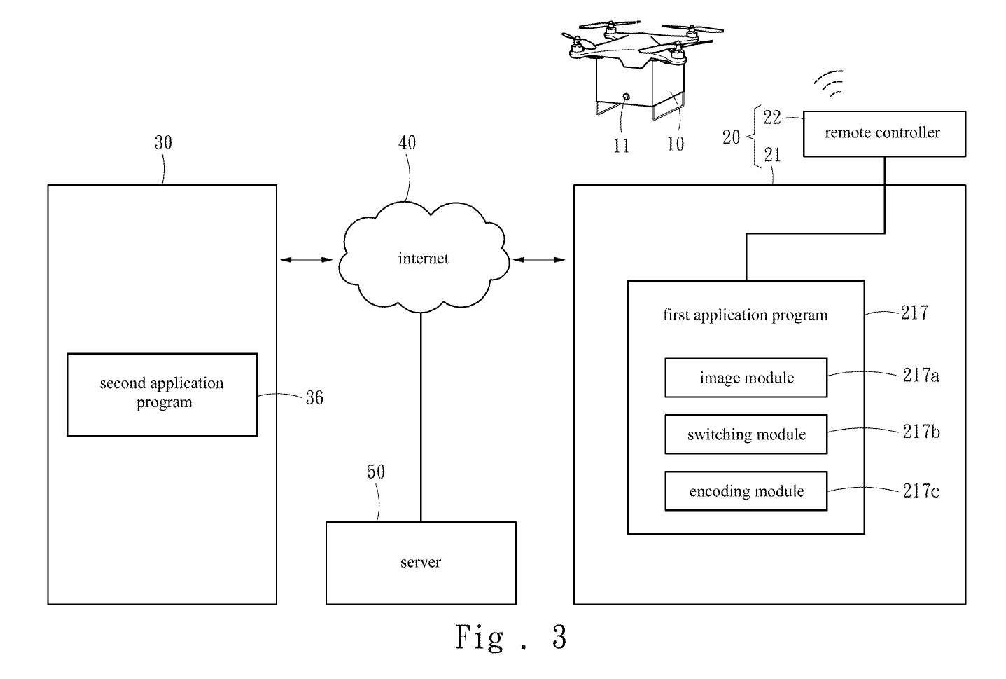

Referring to FIG. 3, there is shown a software configuration diagram of a second embodiment of the present invention. The difference between this embodiment and the first embodiment consists in the system 21 of the near-end remote control device 20 of this embodiment being not shipped with the third application program 218, while the received instruction being encoded again via the encoding module 217c into a format readable by the remote controller 22, in such a way that the unmanned aerial vehicle 10 is manipulated by the user. Furthermore, in the second embodiment of the present invention, step 6 further comprises the steps of:

step 6-1: performing the encoding operation on the first control instruction by the first application program 217 according to a format readable by the remote controller 22, so as to obtain an encoded instruction;

step 6-2: sending a signal by the first application program 217 to the remote controller 22 according to the encoded instruction; and

step 6-3: sending the second control instruction by the remote controller 22 to the unmanned aerial vehicle 10 according to the signal.

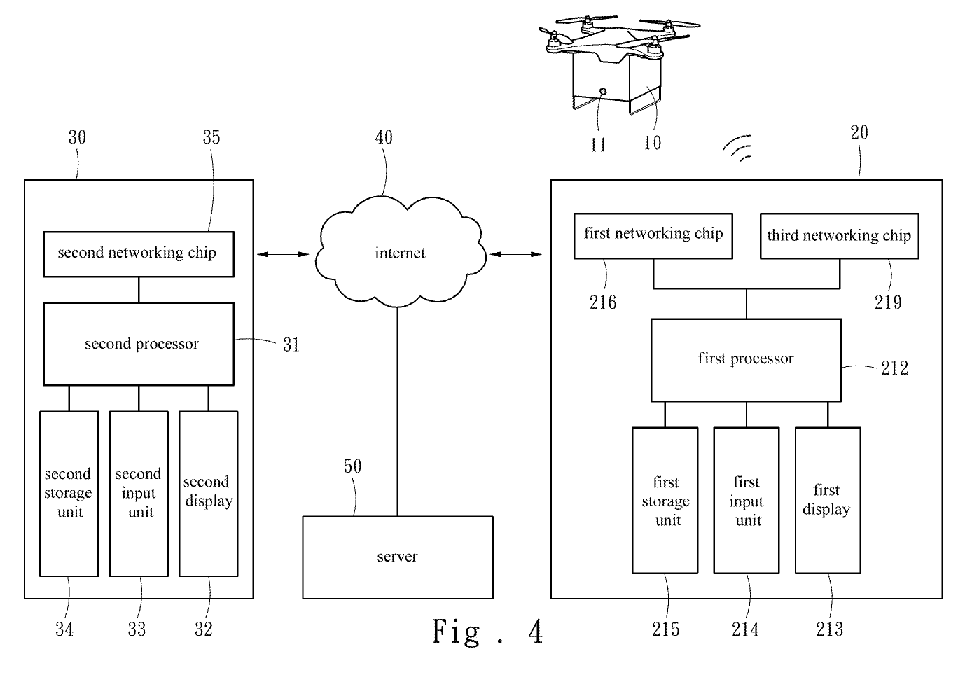

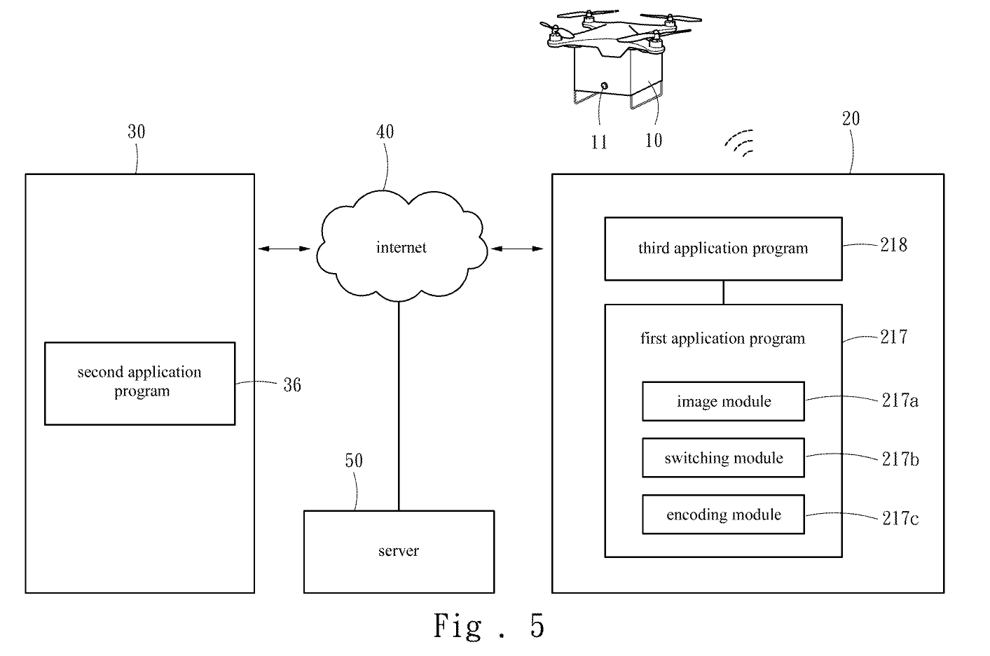

Referring to FIGS. 4 and 5, there are shown a system configuration diagram and a software configuration diagram, respectively, of a third embodiment of the present invention. The difference between the third embodiment and the first embodiment consists in the remote controller 22 being not used in the near-end remote control device 20 of this embodiment, while the remote control module of the near-end remote control device 20 is achieved via a third networking chip 219. Therefore, the received instruction is encoded again via the encoding module 217c into a format readable by the unmanned aerial vehicle 10 directly, in such a way that the unmanned aerial vehicle 10 is manipulated by the user. Furthermore, in the third embodiment of the present invention, step 6 further comprises the steps of:

step 6-1: performing the encoding operation on the first control instruction by the first application program 217 according to a format readable by the third application program 218 predefinedly matched with the unmanned aerial vehicle 10, so as to obtain an encoded instruction;

step 6-2: sending a signal by the first application program 217 to the third networking chip 219 according to the encoded instruction; and

step 6-3: sending the second control instruction by the third networking chip 219 to the unmanned aerial vehicle 10 according to the signal, such that the unmanned aerial vehicle 10 is allowed to carry out a corresponding operation accordingly.

To sum up, the first control instruction emitted by the far-end remote control device may be delivered to the near-end remote control device via the internet, and then encoded by the near-end remote control device, so as to further manipulate the unmanned aerial vehicle at far end without being limited by a remote control distance defined for the unmanned aerial vehicle when leaving the factory. Thereby, it is possible for the user to use the far-end remote control device far away from the unmanned aerial vehicle to operate this unmanned aerial vehicle, with the first control instruction emitted by the far-end remote control device being delivered to the unmanned aerial vehicle module via the internet. The operable distance is increased significantly, since the extending geographic range of the internet is far greater than the communication distance between the near-end remote control device and the unmanned aerial vehicle. Thereby, it is possible for the user afar to operate the unmanned aerial vehicle via the far-end remote control device, and view the image data shot by the unmanned aerial vehicle for the application in the fields of taking care of elderly and children, making the rounds, looking at the scenery and so on. Moreover, the present invention is not restricted to one single user, but allowed to achieve the object of sharing by providing one unmanned aerial vehicle module at a fixed location with the unmanned aerial vehicle module being manipulated by users via individual far-end remote control devices.

What is claimed is:

1. A method of far-end control for unmanned aerial vehicle, comprising:
step 1: providing an unmanned aerial vehicle, a near-end remote control device and a far-end remote control device, said unmanned aerial vehicle not having a hardware components thereon to connect to the internet wirelessly, said near-end remote control device comprising a remote control module predefinedly matched with said unmanned aerial vehicle and used for manipulating said unmanned aerial vehicle wirelessly by using a proprietary protocol instead of via the internet within a predefined geographic range, and said far-end remote control device being far away from said near-end remote control device at a distance of at least said predefined geographic range;
step 2: transmitting an image data which is shot by said unmanned aerial vehicle to said near-end remote control device through said unmanned aerial vehicle;
step 3: transmitting said image data by said near-end remote control device to said far-end remote control device via an internet according to a first network protocol, wherein said first network protocol is selected from the group consisting of 3G wireless network, 4G wireless network, 5G wireless network and TCP/IP;
step 4: receiving said image data by said far-end remote control device and presenting said image data received from said near-end remote control device on a second display of said far-end remote control device;
step 5: sending a first control instruction by said far-end remote control device according to a second network protocol, said first control instruction being transmitted to said near-end remote control device via said internet, wherein said second network protocol is selected from the group consisting of 3G wireless network, 4G wireless network, 5G wireless network and TCP/IP; and
step 6: instructing said unmanned aerial vehicle through said remote control module of said near-end remote control device to allow said unmanned aerial vehicle carrying out a corresponding operation according to said first control instruction.

2. The method of far-end control for unmanned aerial vehicle according to claim 1, wherein said remote control module is a predefinedly matched with said unmanned aerial vehicle.

3. The method of far-end control for unmanned aerial vehicle according to claim 1, wherein said remote control module comprises a system equipped with a processor (CPU) and a networking chip.

4. The method of far-end control for unmanned aerial vehicle according to claim 1, wherein the near-end remote control device comprises a first application program.

5. The method of far-end control for unmanned aerial vehicle according to claim 4, wherein said first application program comprises an image module used for storing said image data.

6. The method of far-end control for unmanned aerial vehicle according to claim 4, wherein said first application program comprises a switching module provided for a user to switch between a near-end remote control mode and a far-end remote control mode.

7. The method of far-end control for unmanned aerial vehicle according to claim 4, wherein said first application program comprises a switching module provided to block the first control instruction from said far-end remote control device so that only a user of the near-end remote control device could control the unmanned aerial vehicle.

8. The method of far-end control for unmanned aerial vehicle according to claim 4, wherein said first application program comprises an encoding module carrying out an encoding operation.
